(19) United States
(12) Patent Application Publication
(10) Pub. No.: US 2025/0300501 A1
(43) Pub. Date: Sep. 25, 2025

(54) STATOR

(71) Applicant: HONDA MOTOR CO., LTD., Tokyo (JP)

(72) Inventor: Keisuke AZUSAWA, Saitama (JP)

(21) Appl. No.: 19/058,128

(22) Filed: Feb. 20, 2025

(30) Foreign Application Priority Data
Mar. 22, 2024 (JP) 2024-045809

(51) Int. Cl. H02K 1/16; H02K 3/28

(52) U.S. Cl. CPC H02K 1/165; H02K 3/28; H02K 2203/09; H02K 2213/03

(57) ABSTRACT

A stator includes: a stator core in which a plurality of slots is formed; and a coil being open winding, in which one pole of one phase includes n (even number) slots, the number of phases is m (2 or 3), an end portion of a winding start is electrically joined to a wire inserted in an outermost diameter turn of a slot, an end portion of a winding end is electrically joined to a wire inserted in an outermost diameter turn of a slot, and a wire wound up to an end of an innermost diameter turn of a slot and a wire inserted in a slot shifted by (n−1)×m−1 slots in a winding direction or a direction opposite to the winding direction from the slot in which the wire is inserted in the innermost diameter turn of the slot are electrically joined.

### BACKGROUND

### Technical Field

The present invention relates to a stator of a rotating electric machine.

### Related Art

In recent years, research and development on miniaturization, weight reduction, yield improvement, and the like that contributes to energy efficiency has been conducted in order for more people to be able to access affordable, reliable, sustainable, and advanced energy. For example, an electric vehicle (EV) uses only a motor as a power source, and thus has an advantage of not discharging carbon dioxide, nitrogen oxides, and the like during traveling, and is expected as a next-generation automobile. Therefore, a technology related to improvement of energy efficiency of a motor mounted on an electric vehicle or the like has been developed. Examples of such a technology include a rotating electric machine disclosed in Japanese Patent Publication No. 3621635.

### CITATION LIST

### Patent Literature

Patent Literature 1: Japanese Patent Publication No. 3621635

### SUMMARY

In the rotating electric machine described above, an end portion of the winding end of the armature winding wound around an armature core is inserted in the innermost diameter turn of a slot. For this reason, in the rotating electrical machine described above, in order to connect the end portion of the winding end of the armature winding to a drive circuit, it is necessary to pull out the end portion from the innermost diameter turn of the slot to the outside of the armature core by using a complicated and long bus bar.

However, since the rotating electric machine described above has such a structure, stress applied to the bus bar due to vibration or the like is amplified by the principle of leverage, and may be applied to a portion where the end portion of the winding end of the armature winding and the bus bar are welded. In addition, since the rotating electric machine described above requires a complicated and long bus bar, a lot of material is required for manufacturing the bus bar, the yield of the bus bar is reduced, and miniaturization is difficult.

The present invention has been made to solve the above problems, and an object of the present invention is to provide a stator capable of pulling out an end portion of the winding end of a coil to the outside of a stator core by using a short bus bar having a simple structure. In addition, the present invention ultimately contributes to energy efficiency.

In order to achieve the above object, a stator according to claim 1 includes: a stator core in which a plurality of slots is formed; and a coil being open winding, in which one pole of one phase includes n (n: even number) slots, the number of phases is m (m: 2 or 3), an end portion of a winding start is electrically joined to a wire inserted in an outermost diameter turn of a slot, an end portion of a winding end is electrically joined to a wire inserted in an outermost diameter turn of a slot, and a wire wound up to an end of an innermost diameter turn of a slot and a wire inserted in a slot shifted by (n−1)×m−1 slots in a winding direction or a direction opposite to the winding direction from the slot in which the wire is inserted in the innermost diameter turn of the slot are electrically joined.

Accordingly, in the stator according to claim 1, it is possible to shorten a bus bar for pulling out the end portion of the winding end of each of the four coils described above from the outermost diameter of the stator core. Therefore, the stator according to claim 1 can suppress stress generated by vibration or the like, amplified by the principle of leverage, and applied to the bus bar. In addition, the stator according to claim 1 can reduce the amount of material required for manufacturing the bus bar and improve the yield of the bus bar. Furthermore, the stator according to claim 1 can make the bus bar simple and short, and can easily miniaturize a two-phase motor.

A stator according to claim 2 includes: a stator core in which a plurality of slots in each of which a wire is capable of being wound p (p: even number) turns is formed; and a coil in which one pole of one phase includes n (n: even number) slots, an end portion of a winding start is electrically joined to a wire inserted in a first turn from an outer diameter side of a slot, an end portion of a winding end is electrically joined to a wire inserted in a second turn from an outer diameter side of a slot, and when the coil is wound from an outer diameter side of a slot to a p-th turn and then folded back to the outer diameter side of the slot, the coil is electrically joined to a wire inserted on an outer diameter side by one turn in a slot shifted by n×2+1 slots in a winding direction, is wound around the stator core once, and is electrically joined to a wire inserted on an outer diameter side by three turns in a slot shifted by n×2+2 slots in the winding direction.

Thus, the stator according to claim 2 can achieve similar effects as those of the stator according to claim 1.

In the stator according to claim 3, a plurality of slots in each of which a wire is capable of being wound p (p: an even number of 6 or more) turns is formed in the stator core. Furthermore, in the stator according to claim 3, the coil is wound up to a second turn from an outer diameter side of the stator core by repeating further electrically joining the coil to a wire inserted on an outer diameter side by three turns in a slot shifted by n×2−2 slots in the winding direction, winding the coil around the stator core once, and electrically joining the coil to a wire inserted on an outer diameter side by three turns in a slot shifted by n×2+2 slots in the winding direction.

Thus, the stator according to claim 3 can achieve similar effects as those of the stator according to claim 1.

In a stator according to claim 4, the coil is open winding, one pole of one phase includes n (n: even number) slots, the number of phases is m (m: 2 or 3), and m×u×2 terminals incorporated in a u-parallel circuit are arranged to be shifted from each other in a direction of a rotation axis of a rotor.

As a result, in the stator according to claim 4, even in a case where the end portion of the winding end of the coil is pulled out to the outside of the stator core by a simple and short bus bar, the insulation distance between the bus bar and the terminal, the insulation distance between the bus bars, and the insulation distance between the terminals can be secured.

In the stator according to claim 5, the coil includes a bus bar that electrically joins a terminal incorporated in a u-parallel circuit and the end portion of the winding start or the end portion of the winding end, and a part of the bus bar from a portion starting to overlap a back yoke of the stator core in a direction of a rotation axis of a rotor to the end portion of the winding start or the end portion of the winding end is laid in a region overlapping the back yoke in the direction of the rotation axis.

As a result, the stator according to claim 5 can reduce the size of the two-phase motor.

In a stator according to claim 6, the coil is open winding, one pole of one phase includes n (n: an even number) slots, the number of phases is m (m: 2 or 3), and a slot in which an end portion of a winding start of a first phase is inserted and a slot in which an end portion of a winding start of a second phase different from the first phase is inserted are arranged apart from each other by n×2 slots or more.

As a result, in the stator according to claim 6, the number of portions where the bus bars for pulling out the end portions of the winding ends of the coils from the stator core complicatedly overlap each other in the direction of the rotation axis of the rotor can be reduced. Therefore, the stator according to claim 6 can easily miniaturize the two-phase motor.

### BRIEF DESCRIPTION OF DRAWINGS

FIG. 1 is a diagram illustrating an example of how a coil is wound and joining by a bus bar according to a first embodiment;

FIG. 2 is a diagram illustrating an example of how a coil is wound and joining by bus bars according to a second embodiment;

FIG. 3 is a view illustrating an example of arrangement of terminals according to a third embodiment; and

FIG. 4 is a view illustrating an example of a positional relationship between a slot in which an end portion of a winding start of a first phase is inserted and a slot in which an end portion of a winding start of a second phase is inserted according to a fourth embodiment.

### DETAILED DESCRIPTION

Hereinafter, embodiments of the present invention will be described with reference to the drawings. In the first to fourth embodiments, a two-phase motor which is an example of a rotating electric machine according to the present invention will be described. This motor is mounted on, for example, an electric vehicle in order to rotate a tire of the electric vehicle.

### First Embodiment

A two-phase motor according to the first embodiment includes a stator and a rotor. The stator includes a stator core and a coil.

The stator core is a cylindrical member in which a plurality of teeth and slots are formed inside. The teeth are portions of the stator core extending toward the rotation axis A of the rotor, and the shape and dimension of the cross section taken along an arbitrary plane orthogonal to the rotation axis A are the same regardless of the position where the rotation axis A and the plane are orthogonal to each other. The slot is a space sandwiched between two teeth adjacent in the circumferential direction of a circle centered on a point on the rotation axis A and located on an arbitrary plane orthogonal to the rotation axis A.

The coil is a wire wound around the teeth. Specifically, the coil is configured by being wound around the entire stator core by repeating a structure in which an end portion of a U-shaped rectangular wire is electrically joined to an end portion of another U-shaped rectangular wire, the U-shaped rectangular wires being inserted in two slots. The coil is open winding whose both ends are incorporated in an inverter circuit, and generates a magnetic force for rotating the rotor around the rotation axis A when energized by the inverter circuit.

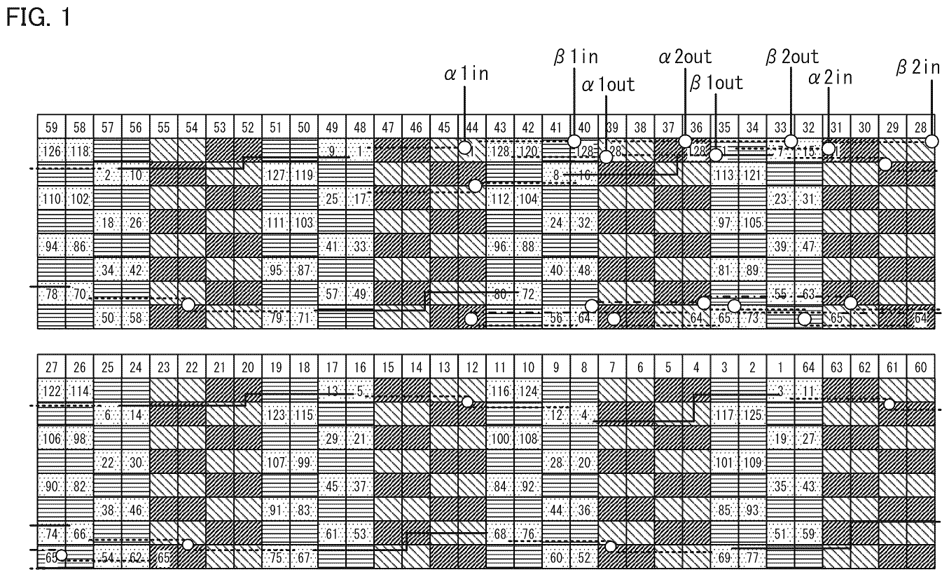

FIG. 1 is a diagram illustrating an example of how a coil is wound and joining by a bus bar according to the first embodiment. FIG. 1 illustrates an example of a case where one pole of one phase includes an even number n=four slots, and the number of phases is m=two. Therefore, the two-phase motor according to the first embodiment includes a coil α1 and a coil α2 constituting an α phase, and a coil β1 and a coil β2 constituting a β phase. Note that FIG. 1 mainly illustrates an example of how the coil α1 is wound and joining by a bus bar.

Each cell in the first row from the top in FIG. 1 indicates a slot number assigned to the corresponding slot formed in the stator core. As indicated in the first row from the top in FIG. 1, 64 slots are formed in the stator core. Each cell in the second to ninth rows from the top in FIG. 1 indicates a position where one of the end portions of the U-shaped rectangular wire is inserted in the corresponding slot. The position numbers in these cells indicate the order in which the rectangular wires forming the coil of each phase pass.

A dot-hatched cell indicates a position where the rectangular wire constituting the coil α1 is inserted. A cell hatched with vertical lines indicates a position where the rectangular wire constituting the coil α2 is inserted. A cell with dark diagonal hatching indicates a position where the rectangular wire constituting the coil β1 is inserted. A cell with light diagonal hatching indicates a position where the rectangular wire constituting the coil β2 is inserted.

The second line, the third line, . . . , and the ninth line from the top in FIG. 1 illustrate the first turn, the second turn, . . . , and the eighth turn from the outer diameter side toward the inner diameter side of the stator core, respectively. The term “turn” used herein refers to 64 cells located at a certain distance from the outer diameter side of the stator core in the radial direction of the circle centered on a point on the rotation axis A and located on a plane orthogonal to the rotation axis A.

A solid line illustrated in FIG. 1 indicates that the curved portion of the U-shaped rectangular wire protrudes in a direction from the back to the front of the paper surface of FIG. 1. A dotted line illustrated in FIG. 1 indicates that the end portion of the U-shaped rectangular wire protrudes in a direction from the front to the back of the paper surface of FIG. 1. An alternate long and short dash line illustrated in FIG. 1 indicates a bus bar that electrically joins end portions of the U-shaped rectangular wires. A white circle illustrated in FIG. 1 indicates a portion that is welded to electrically join end portions of the U-shaped rectangular wires.

Specific examples of how the coil α1 is wound, joining by the bus bar, and the winding starts and the winding ends of the coil α2, the coil β1, and the coil β2 will be described with reference to FIG. 1.

As illustrated in FIG. 1, an end portion α1in of the winding start of the coil α1 is electrically joined to an end portion of the rectangular wire inserted in the first turn, which is the outermost diameter turn of slot number 48, in the vicinity of the position of the first turn of slot number 44 with light diagonal hatching.

The coil α1 includes a rectangular wire in which an end portion arranged on the right side in FIG. 1 is inserted at the position of position number 1 of the first turn and an end portion arranged on the left side in FIG. 1 is inserted at the position of position number 2 of the second turn. The coil α1 includes a rectangular wire in which an end portion arranged on the right side in FIG. 1 is inserted at the position of position number 3 of the first turn and is electrically joined to the end portion of the rectangular wire inserted at the position of position number 2 and an end portion arranged on the left side in FIG. 1 is inserted at the position of position number 4 of the second turn.

The coil α1 includes a rectangular wire in which an end portion arranged on the right side in FIG. 1 is inserted at the position of position number 5 of the first turn and is electrically joined to the end portion of the rectangular wire inserted at the position of position number 4 and an end portion arranged on the left side in FIG. 1 is inserted at the position of position number 6 of the second turn. The coil α1 includes a rectangular wire in which an end portion arranged on the right side in FIG. 1 is inserted at the position of position number 7 of the first turn and is electrically joined to the end portion of the rectangular wire inserted at the position of position number 6 and an end portion arranged on the left side in FIG. 1 is inserted at the position of position number 8 of the second turn.

The coil α1 is wound around the first turn and the second turn of the stator core by the above-described four rectangular wires. In addition, the coil α1 is wound from the third turn to the eighth turn of the stator core by the structure similar to the above-described structure. Note that from the winding start position of the coil α1 to the position of position number 64, the direction from the right to the left in FIG. 1 is the winding direction. In addition, from the winding start position of the coil α1 to the position of position number 64, the direction from the left to the right in FIG. 1 is the direction opposite to the winding direction.

The coil α1 includes a bus bar that electrically joins a wire wound up to the end of the innermost diameter turn of the slot and a wire inserted in a slot shifted by (n−1)×m−1 slots in the direction opposite to the winding direction from the slot in which the wire is inserted in the innermost diameter turn of the slot. Specifically, the coil α1 includes a bus bar that electrically joins an end portion of the rectangular wire inserted at the position of position number 64 and an end portion of the rectangular wire inserted at the position of position number 65 of the slot shifted rightward from the slot in which the end portion is inserted by (4−1)×2−1=five slots.

This bus bar is electrically joined to the end portion of the rectangular wire inserted at the position of position number 64 in the vicinity of the position of the eighth turn of slot number 44. In addition, this bus bar is electrically joined to the end portion of the rectangular wire inserted at the position of position number 65 in the vicinity of the position of the eighth turn of slot number 39. Note that this bus bar is indicated by an alternate long and short dash line in FIG. 1.

The coil α1 includes a rectangular wire in which an end portion arranged on the left side in FIG. 1 is inserted at the position of position number 65 of the eighth turn and an end portion arranged on the right side in FIG. 1 is inserted at the position of position number 66 of the seventh turn. The coil α1 includes a rectangular wire in which an end portion arranged on the left side in FIG. 1 is inserted at the position of position number 67 of the eighth turn and is electrically joined to the end portion of the rectangular wire inserted at the position of position number 66 and an end portion arranged on the right side in FIG. 1 is inserted at the position of position number 68 of the seventh turn.

The coil α1 includes a rectangular wire in which an end portion arranged on the left side in FIG. 1 is inserted at the position of position number 69 of the eighth turn and is electrically joined to the end portion of the rectangular wire inserted at the position of position number 68 and an end portion arranged on the right side in FIG. 1 is inserted at the position of position number 70 of the seventh turn. The coil α1 includes a rectangular wire in which an end portion arranged on the left side in FIG. 1 is inserted at the position of position number 71 of the eighth turn and is electrically joined to the end portion of the rectangular wire inserted at the position of position number 70 and an end portion arranged on the right side in FIG. 1 is inserted at the position of position number 72 of the seventh turn.

The coil α1 is wound around the eight turn and the seventh turn of the stator core by the above-described four rectangular wires. In addition, the coil α1 is wound from the sixth turn to the first turn of the stator core by the structure similar to the above-described structure. Note that from the position of position number 65 to the winding end position of the coil α1, the direction from the left to the right in FIG. 1 is the winding direction. In addition, from the position of position number 65 to the winding end position of the coil α1, the direction from the right to the left in FIG. 1 is the direction opposite to the winding direction.

As illustrated in FIG. 1, an end portion α1out of the winding end of the coil α1 is electrically joined to an end portion of the rectangular wire inserted in the first turn, which is the outermost diameter turn of slot number 43, in the vicinity of the position of the first turn of slot number 128 with dark diagonal hatching.

As illustrated in FIG. 1, an end portion α2in of the winding start of the coil α2 is electrically joined to an end portion of the rectangular wire inserted in the first turn, which is the outermost diameter turn of slot number 35, in the vicinity of the position of the first turn of slot number 31 with dark diagonal hatching.

The coil α2 is first wound up to the end of the innermost diameter turn of the slot in the direction from the right to the left in FIG. 1 in a manner similar to that in the coil α1. Next, the winding direction of the coil α2 is reversed, that is, from the left to the right in FIG. 1 by a bus bar similar to that of the coil α1. Then, the coil α2 is wound up to the end of the outermost diameter turn of the slot in the direction from the left to the right in FIG. 1 in a manner similar to that in the coil α1.

As illustrated in FIG. 1, an end portion α2out of the winding end of the coil α2 is electrically joined to an end portion of the rectangular wire inserted in the first turn, which is the outermost diameter turn of slot number 40, in the vicinity of the position of the first turn of slot number 36 with dark diagonal hatching.

As illustrated in FIG. 1, an end portion β1in of the winding start of the coil β1 is electrically joined to an end portion of the rectangular wire inserted in the first turn, which is the outermost diameter turn of slot number 44, in the vicinity of the position of the first turn of slot number 128 with vertical line hatching.

The coil β1 is first wound up to the end of the innermost diameter turn of the slot in the direction from the right to the left in FIG. 1 in a manner similar to that in the coil α1. Next, the winding direction of the coil β1 is reversed, that is, from the left to the right in FIG. 1 by a bus bar similar to that of the coil α1. Then, the coil β1 is wound up to the end of the outermost diameter turn of the slot in the direction from the left to the right in FIG. 1 in a manner similar to that in the coil α1.

As illustrated in FIG. 1, an end portion β1out of the winding end of the coil β1 is electrically joined to an end portion of the rectangular wire inserted in the first turn, which is the outermost diameter turn of slot number 39, in the vicinity of the position of the first turn of slot number 35 with vertical line hatching.

As illustrated in FIG. 1, an end portion β2in of the winding start of the coil β2 is electrically joined to an end portion of the rectangular wire inserted in the first turn, which is the outermost diameter turn of slot number 31, in the vicinity of the position of the first turn of slot number 28 with light diagonal hatching.

The coil β2 is first wound up to the end of the innermost diameter turn of the slot in the direction from the right to the left in FIG. 1 in a manner similar to that in the coil β1. Next, the winding direction of the coil β2 is reversed, that is, from the left to the right in FIG. 1 by a bus bar similar to that of the coil β1. Then, the coil β2 is wound up to the end of the outermost diameter turn of the slot in the direction from the left to the right in FIG. 1 in a manner similar to that in the coil β1.

As illustrated in FIG. 1, an end portion β2out of the winding end of the coil β2 is electrically joined to an end portion of the rectangular wire inserted in the first turn, which is the outermost diameter turn of slot number 36, in the vicinity of the position of the first turn of slot number 33 with light diagonal hatching.

The two-phase motor according to the first embodiment has been described above. The two-phase motor according to the first embodiment includes the coil α1, the coil α2, the coil β1, and the coil β2 which are open winding, and one pole of one phase includes an even number n=four slots, and the number of phases is m=two. In each of the four coils, an end portion of the winding start is electrically joined to the wire inserted in the outermost diameter turn of a slot, and an end portion of the winding end is electrically joined to the wire inserted in the outermost diameter turn of a slot. In addition, each of the four coils includes a bus bar that electrically joins a wire wound up to the end of the innermost diameter turn of a slot and a wire inserted in a slot shifted by five slots in the direction opposite to the winding direction from the slot in which the wire is inserted in the innermost diameter turn of the slot.

Accordingly, in the two-phase motor according to the first embodiment, it is possible to shorten the bus bars for pulling out end portions of the winding ends of the four coils described above from the outermost diameter of the stator core. Therefore, the two-phase motor according to the first embodiment can suppress stress generated by vibration or the like, amplified by the principle of leverage and applied to the bus bar. In addition, the two-phase motor according to the first embodiment can reduce the amount of material required for manufacturing the bus bar and improve the yield of the bus bar. Furthermore, the two-phase motor according to the first embodiment can make the bus bar simple and short, and can easily miniaturize the two-phase motor.

Note that in the first embodiment, a case where the coil α1 includes the bus bar that electrically joins a wire wound up to the end of the innermost diameter turn of a slot and a wire inserted in a slot shifted by (n−1)×m−1 slots in the direction opposite to the winding direction from the slot in which the wire is inserted in the innermost diameter turn of the slot has been described as an example, however, the present invention is not limited thereto. That is, depending on the manner of winding, the coil α1 may include a bus bar that electrically joins a wire wound up to the end of the innermost diameter turn of the slot and a wire inserted in a slot shifted by (n−1)×m−1 slots in the winding direction from the slot in which the wire is inserted in the innermost diameter turn of the slot.

### Second Embodiment

A two-phase motor according to a second embodiment includes a stator core different from that of the first embodiment and a coil wound differently from that of the first embodiment. Therefore, in the description of the second embodiment, contents different from those of the above-described embodiment will be mainly described, and description of contents overlapping with those of the above-described embodiment will be appropriately omitted.

In the stator core, a plurality of slots in each of which a wire can be wound p (p: an even number of 6 or more) turns is formed. For example, in the second embodiment, a plurality of slots in each of which a wire can be wound p=eight turns is formed in the stator core.

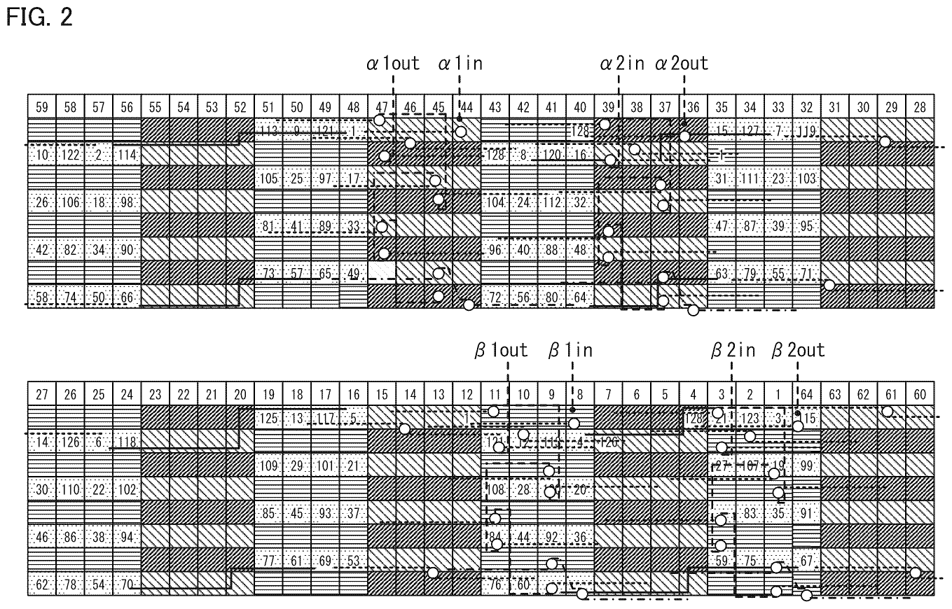

FIG. 2 is a diagram illustrating an example of how a coil is wound and joining by bus bars according to a second embodiment. FIG. 2 illustrates an example of a case where one pole of one phase includes an even number n=four slots, and the number of phases is m=two. Therefore, the two-phase motor according to the second embodiment includes a coil α1 and a coil α2 constituting an α phase, and a coil β1 and a coil β2 constituting a β phase. Note that FIG. 2 mainly illustrates an example of how the coil α1 is wound and joining by bus bars. In addition, the notation used in FIG. 2 is similar to the notation used in FIG. 1.

Specific examples of how the coil α1 is wound, joining by the bus bars, and the winding starts and the winding ends of the coil α2, the coil β1, and the coil β2 will be described with reference to FIG. 2.

As illustrated in FIG. 2, an end portion α1in of the winding start of the coil α1 is electrically joined to an end portion of the rectangular wire inserted in the first turn, which is the outermost diameter turn of slot number 48, in the vicinity of the position of the first turn of slot number 44 with light diagonal hatching.

The coil α1 includes a rectangular wire in which an end portion arranged on the right side in FIG. 2 is inserted at the position of position number 1 of the first turn and an end portion arranged on the left side in FIG. 2 is inserted at the position of position number 2 of the second turn. The coil α1 includes a rectangular wire in which an end portion arranged on the right side in FIG. 2 is inserted at the position of position number 3 of the first turn and is electrically joined to the end portion of the rectangular wire inserted at the position of position number 2 and an end portion arranged on the left side in FIG. 2 is inserted at the position of position number 4 of the second turn.

The coil α1 includes a rectangular wire in which an end portion arranged on the right side in FIG. 2 is inserted at the position of position number 5 of the first turn and is electrically joined to the end portion of the rectangular wire inserted at the position of position number 4 and an end portion arranged on the left side in FIG. 2 is inserted at the position of position number 6 of the second turn. The coil α1 includes a rectangular wire in which an end portion arranged on the right side in FIG. 2 is inserted at the position of position number 7 of the first turn and is electrically joined to the end portion of the rectangular wire inserted at the position of position number 6 and an end portion arranged on the left side in FIG. 2 is inserted at the position of position number 8 of the second turn.

The coil α1 is wound around the first turn and the second turn of the stator core by the above-described four rectangular wires. In addition, the coil α1 is wound from the third turn to the eighth turn of the stator core by the structure similar to the above-described structure. Note that from the winding start position to the winding end position of the coil α1, the direction from the right to the left in FIG. 2 is the winding direction. In addition, from the winding start position to the winding end position of the coil α1, the direction from the left to the right in FIG. 2 is the direction opposite to the winding direction.

The coil α1 includes bus bars electrically joined to a wire inserted on an outer diameter side by one turn in a slot shifted by n×2+1 slots in the winding direction when the coil α1 is wound from the outer diameter side of the slot to the p-th turn and then folded back to the outer diameter side of the slot. Specifically, when the coil α1 is wound up to the eighth turn from the outer diameter side of the slot and then folded back to the outer diameter side of the slot, the coil α1 is electrically joined to a wire inserted on the outer diameter side by one turn in a slot shifted by n×2+1=4×2+1=nine slots in the winding direction. This joining is realized by three bus bars as indicated by alternate long and short dash lines in FIG. 2.

The first bus bar is arranged on the left side in FIG. 2, and electrically joins an end portion of the rectangular wire inserted at the position of position number 64 of the slot of slot number 40 and an end portion of the second bus bar arranged on the right side in FIG. 2. The second bus bar electrically joins an end portion of the first bus bar arranged on the left side in FIG. 2 and an end portion of the third bus bar arranged on the right side in FIG. 2. The third bus bar electrically joins an end portion of the second bus bar arranged on the left side in FIG. 2 and an end portion of a rectangular wire arranged on the right side in FIG. 2 and inserted at a position of position number 65 of slot number 49. Thereafter, the coil α1 is wound around the stator core once.

The coil α1 includes bus bars electrically joined to a wire inserted on the outer diameter side by three turns in a slot shifted by n×2+2 slots in the winding direction. Specifically, the coil α1 is electrically joined to a wire inserted on the outer diameter side by three turns in a slot shifted by n×2+2=4×2+2=ten slots in the winding direction. This joining is realized by three bus bars as indicated by alternate long and short dash lines in FIG. 2.

The first bus bar is arranged on the left side in FIG. 2, and electrically joins an end portion of the rectangular wire inserted at the position of position number 80 of the slot of slot number 41 and an end portion of the second bus bar arranged in the vicinity of the eighth turn of the slot of slot number 45. The second bus bar electrically joins an end portion of the first bus bar arranged on the left side in FIG. 2 and an end portion of the third bus bar arranged on the right side in FIG. 2. The third bus bar electrically joins an end portion of the second bus bar arranged in the vicinity of the fifth turn of the slot of slot number 47 and an end portion of the rectangular wire arranged on the right side in FIG. 2 and inserted at the position of position number 81 of the slot of slot number 51.

The coil α1 further includes bus bars electrically joined to a wire inserted on the outer diameter side by three turns in a slot shifted by n×2−2 slots in the winding direction. Specifically, the coil α1 is electrically joined to a wire inserted on the outer diameter side by three turns in a slot shifted by n×2−2=4×2−2=six slots in the winding direction. This joining is realized by three bus bars as indicated by alternate long and short dash lines in FIG. 2.

The first bus bar is arranged on the left side in FIG. 2, and electrically joins an end portion of the rectangular wire inserted at the position of position number 96 of the slot of slot number 43 and an end portion of the second bus bar arranged in the vicinity of the sixth turn of the slot of slot number 47. The second bus bar electrically joins an end portion of the first bus bar arranged on the left side in FIG. 2 and an end portion of the third bus bar arranged in the vicinity of the third turn of the slot of slot number 45. The third bus bar electrically joins an end portion of the second bus bar arranged in the vicinity of the third turn of the slot of slot number 45 and an end portion of the rectangular wire arranged on the right side in FIG. 2 and inserted at the position of position number 97 of the slot of slot number 49. Thereafter, the coil α1 is wound around the stator core once.

The coil α1 includes bus bars electrically joined to a wire inserted on the outer diameter side by three turns in a slot shifted by n×2+2 slots in the winding direction. Specifically, the coil α1 is electrically joined to a wire inserted on the outer diameter side by three turns in a slot shifted by n×2+2=4×2+2=ten slots in the winding direction. This joining is realized by three bus bars as indicated by alternate long and short dash lines in FIG. 2.

The first bus bar is arranged on the left side in FIG. 2, and electrically joins an end portion of the rectangular wire inserted at the position of position number 112 of the slot of slot number 41 and an end portion of the second bus bar arranged in the vicinity of the fourth turn of the slot of slot number 45. The second bus bar electrically joins an end portion of the first bus bar arranged on the left side in FIG. 2 and an end portion of the third bus bar arranged in the vicinity of the fourth turn of slot number 45. The third bus bar electrically joins an end portion of the second bus bar arranged in the vicinity of the first turn of the slot of slot number 47 and an end portion of the rectangular wire arranged on the right side in FIG. 2 and inserted at the position of position number 113 of the slot of slot number 51.

The coil α1 is wound up to the second turn from the outer diameter side of the stator core by repeating the above-described structure.

As illustrated in FIG. 2, an end portion α1out of the winding end of the coil α1 is electrically joined to an end portion of the rectangular wire inserted in a second turn from the outermost diameter side of slot number 43, in the vicinity of the position of the second turn of slot number 47 with dark diagonal hatching.

As illustrated in FIG. 2, an end portion α2in of the winding start of the coil α2 is electrically joined to an end portion of the rectangular wire inserted in the second turn of slot number 35, in the vicinity of the position of the second turn of slot number 39 with light diagonal hatching. The coil α2 includes bus bars similar to those of the coil α1, and is wound around the stator core by a winding method similar to that of the coil α1. As illustrated in FIG. 2, an end portion α2out of the winding end of the coil α2 is electrically joined to an end portion of the rectangular wire inserted in the first turn, which is the outermost diameter turn of slot number 40, in the vicinity of the position of the first turn of slot number 36 with dark diagonal hatching.

As illustrated in FIG. 2, an end portion β1in of the winding start of the coil β1 is electrically joined to an end portion of the rectangular wire inserted in the first turn, which is the outermost diameter turn of slot number 12, in the vicinity of the position of the first turn of slot number 8 with vertical line hatching. The coil β1 includes bus bars similar to those of the coil α1, and is wound around the stator core by a winding method similar to that of the coil α1. As illustrated in FIG. 2, an end portion β1out of the winding end of the coil β1 is electrically joined to an end portion of the rectangular wire inserted in the second turn of slot number 7, in the vicinity of the position of the second turn of slot number 11 with dot hatching.

As illustrated in FIG. 2, an end portion β2in of the winding start of the coil β2 is electrically joined to an end portion of the rectangular wire inserted in the second turn of slot number 63, in the vicinity of the position of the second turn of slot number 3 with vertical line hatching. The coil β2 includes bus bars similar to those of the coil α1, and is wound around the stator core by a winding method similar to that of the coil α1. As illustrated in FIG. 2, an end portion β2out of the winding end in of the coil β2 is electrically joined to an end portion of the rectangular wire inserted in the first turn, which is the outermost diameter turn of slot number 4, in the vicinity of the position of the first turn of slot number 64 with dot hatching.

The two-phase motor according to the second embodiment has been described above. The two-phase motor according to the second embodiment includes the stator core in which the plurality of slots in each of which a wire can be wound p (p: an even number of 6 or more) turns is formed.

In addition, the two-phase motor according to the second embodiment includes the coil α1, the coil α2, the coil β1, and the coil β2, which are open winding, and one pole of one phase includes an even number n=four slots, and the number of phases is m=two. In each of the four coils, an end portion of the winding start is electrically joined to the wire inserted in the first turn from the outermost diameter side of a slot, and an end portion of the winding end is electrically joined to the wire inserted in the second turn from the outermost diameter side of a slot.

In addition, when each of the four coils is wound up to the eighth turn from the outer diameter side of the slot and then folded back to the outer diameter side of the slot, the coil is electrically joined to a wire inserted on outer diameter side by one turn in a slot shifted by 4×2+1=nine slots in the winding direction. Furthermore, each of the four coils is wound around the stator core once and then electrically joined to a wire inserted on the outer diameter side by three turns in a slot shifted by 4×2+2=ten slots in the winding direction.

As a result, the two-phase motor according to the second embodiment can achieve effects similar to those of the two-phase motor according to the first embodiment.

In addition, the four coils are wound as follows in a case where a plurality of slots in which a wire can be wound p (p: an even number of 6 or more) turns is formed in the stator core. Each of the four coils is electrically joined to a wire inserted on the outer diameter side by three turns in a slot shifted by n×2−2 slots in the winding direction. Furthermore, each of the four coils is wound around the stator core once and then electrically joined to a wire inserted on the outer diameter side by three turns in a slot shifted by 4×2+2=ten slots in the winding direction. Each of the four coils is wound up to the second turn from the outer diameter side of the stator core by repeating the above-described structure.

As a result, the two-phase motor according to the second embodiment can achieve effects similar to those of the two-phase motor according to the first embodiment even in a case where a plurality of slots in each of which a wire can be wound p (p: an even number of 6 or more) turns is formed in the stator core.

Note that in the second embodiment, a case where a plurality of slots in each of which a wire can be wound p (p: an even number of 6 or more) turns is formed in the stator core has been described as an example, but the present invention is not limited thereto. In the stator core according to the second embodiment, a plurality of slots in each of which a wire can be wound p (p: an even number) turns may be formed. Therefore, in the stator core according to the second embodiment, a plurality of slots in each of which a wire can be wound two turns or four turns may be formed.

### Third Embodiment

A two-phase motor according to a third embodiment includes a stator core similar to that of the first embodiment or the second embodiment and a coil wound similarly to that of the first embodiment or the second embodiment. However, the two-phase motor according to the third embodiment includes terminals arranged in a manner different from that of the above-described embodiments. Therefore, in the description of the third embodiment, contents different from those of the above-described embodiments will be mainly described, and description of contents overlapping with those of the above-described embodiments will be appropriately omitted.

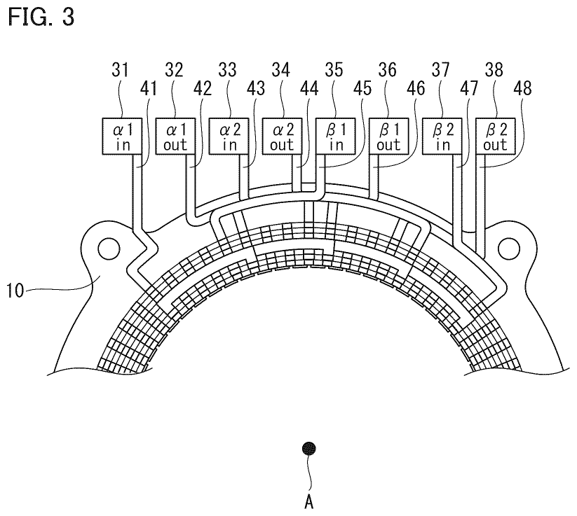

FIG. 3 is a view illustrating an example of arrangement of terminals according to the third embodiment. As illustrated in FIG. 3, the two-phase motor according to the third embodiment includes a stator core 10, terminals 31, 32, . . . , and 38, and bus bars 41, 42, . . . , and 48. The stator core 10 is similar to the stator core according to the first embodiment or the stator core according to the second embodiment. Note that the coil is open winding, one pole of one phase includes an n (n: even number) slots, and the number of phases is m=two.

The terminals 31, 32, . . . , and 38 are examples of m×u×2=2×2×2=eight terminals incorporated in a u=two-parallel circuit.

The terminal 31 is a part of a coil α1, and is electrically joined to an end portion α1in of the winding start of the coil α1 by the bus bar 41. The terminal 32 is a part of the coil α1, and is electrically joined to an end portion α1out of the winding end of the coil α1 by the bus bar 42. The terminal 33 is a part of a coil α2, and is electrically joined to an end portion α2in of the winding start of the coil α2 by the bus bar 43. The terminal 34 is a part of the coil α2, and is electrically joined to an end portion α2out of the winding end of the coil α2 by the bus bar 44.

The terminal 35 is a part of a coil β1, and is electrically joined to an end portion β1in of the winding start of the coil β1 by the bus bar 45. The terminal 36 is a part of the coil β1, and is electrically joined to an end portion β1out of the winding end of the coil β1 by the bus bar 46. The terminal 37 is a part of a coil β2, and is electrically joined to an end portion β2in of the winding start of the coil β2 by the bus bar 47. The terminal 38 is a part of the coil β2, and is electrically joined to an end portion β2out of the winding end of the coil β2 by the bus bar 48.

In addition, the terminals 31, 32, . . . , and 38 are arranged to be shifted from each other in the direction of the rotation axis A of a rotor. Specifically, the terminals 31, 32, . . . , and 38 are arranged at positions different from the positions of the terminals adjacent in the left-right direction in FIG. 3 in the direction of the rotation axis A. For example, the position of the terminal 31 in the direction of the rotation axis A is different from that of the terminal 32. In addition, for example, the position of the terminal 35 in the direction of the rotation axis A is different from those of the terminals 34 and 36. The same applies to the terminals other than the terminals 31 and 35.

As illustrated in FIG. 3, a part of the bus bar 41 from the portion starting to overlap a back yoke of the stator core in the direction of the rotation axis A to the end portion α1in of the winding start is laid in a region overlapping with the back yoke in the direction of the rotation axis A. The back yoke is a portion of the stator core that is farther from the rotation axis A than the portion where the slots are formed. In addition, the portion where the back yoke of the stator core and the bus bar 41 start to overlap in the direction of the rotation axis A is the portion where the back yoke and the bus bar 41 first overlap in the direction of the rotation axis A in a case where the bus bar 41 is traced from the terminal 31 toward the slot.

Similarly, as illustrated in FIG. 3, a part of the bus bar 42 from the portion starting to overlap the back yoke of the stator core in the direction of the rotation axis A to the end portion α1out of the winding end is laid in a region overlapping with the back yoke in the direction of the rotation axis A. In addition, the portion where the back yoke of the stator core and the bus bar 42 start to overlap in the direction of the rotation axis A is the portion where the back yoke and the bus bar 42 first overlap in the direction of the rotation axis A in a case where the bus bar 42 is traced from the terminal 32 toward the slot.

In addition, the positional relationship between the bus bar 41 or the bus bar 42 and the back yoke described above also applies to the bus bars 43, 44, . . . , and 48.

The two-phase motor according to the third embodiment has been described above. The two-phase motor according to the third embodiment includes a coil in which m×u×2=2×2×2=eight terminals incorporated in a u=two-parallel circuit are arranged to be shifted from each other in the direction of the rotation axis of the rotor.

As a result, in the two-phase motor according to the third embodiment, even in a case where the end portion of the winding end of the coil is pulled out to the outside of the stator core by the simple and short bus bar, the insulation distance between the bus bar and the terminal, the insulation distance between the bus bars, and the insulation distance between the terminals can be secured.

In addition, the two-phase motor according to the third embodiment includes the bus bars 41, 42, . . . , and 48. A part of each of the eight bus bars from the portion starting to overlap the back yoke in the direction of the rotation axis A to the end portion of the winding start or the end portion of the winding end is laid in a region overlapping the back yoke in the direction of the rotation axis A.

As a result, the two-phase motor according to the third embodiment can reduce the size thereof.

### Fourth Embodiment

A two-phase motor according to a fourth embodiment includes a stator core similar to that of the first embodiment or the second embodiment and a coil wound similarly to that of the first embodiment or the second embodiment. However, the two-phase motor according to the fourth embodiment is different from the above-described embodiments in the positional relationship between a slot in which an end portion of a winding start of a first phase is inserted and a slot in which an end portion of a winding start of a second phase different from the first phase is inserted. Therefore, in the description of the fourth embodiment, contents different from those of the above-described embodiments will be mainly described, and description of contents overlapping with those of the above-described embodiments will be appropriately omitted.

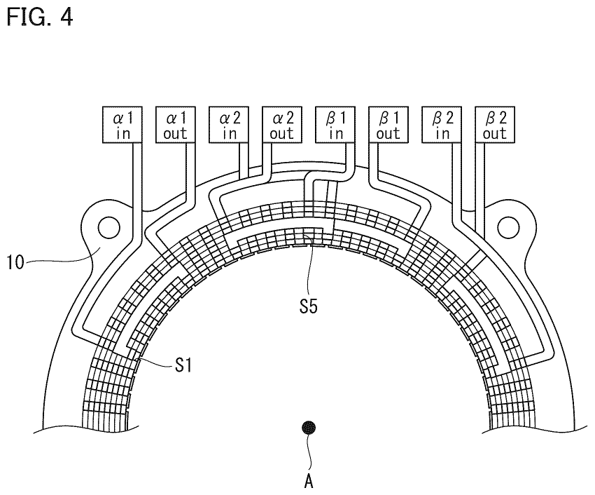

FIG. 4 is a view illustrating an example of the positional relationship between the slot in which the end portion of the winding start of the first phase is inserted and the slot in which the end portion of the winding start of the second phase is inserted according to the fourth embodiment. As illustrated in FIG. 4, the two-phase motor according to the fourth embodiment includes a stator core 10, a slot S1, and a slot S5. The stator core 10 is similar to the stator core according to the first embodiment or the stator core according to the second embodiment. Note that the coil is open winding, and the number of phases each including n (n: even number) slots is m=two.

The end portion of the winding start of the first phase is inserted in the slot S1. Specifically, an end portion α1in of a coil α1 of an α phase is inserted in the slot S1. The end portion of the winding start of the second phase different from the first phase is inserted in the slot S5. Specifically, an end portion β1in of a coil β1 of a β phase is inserted in the slot S5. In addition, as illustrated in FIG. 4, the slot S1 and the slot S5 are arranged apart from each other by n×2=4×2=eight slots or more.

The two-phase motor according to the fourth embodiment has been described above. The two-phase motor according to the fourth embodiment includes the coil in which the slot S1 in which the end portion α1in of the winding start of the coil α1 of the α phase is inserted and the slot S5 in which the end portion β1in of the coil β1 of the β phase is inserted are arranged apart from each other by n×2=4×2=eight slots or more.

As a result, in the two-phase motor according to the fourth embodiment, the number of portions where bus bars for pulling out the end portions of the winding ends of the coils from the stator core complicatedly overlap each other in the direction of the rotation axis A can be reduced. Therefore, the two-phase motor according to the fourth embodiment can easily miniaturize the two-phase motor.

Note that in the above-described embodiments, the case where the rotating electric machine according to the embodiment is a two-phase motor, that is, the case where the number of phases m is two has been described as an example, but the present invention is not limited thereto. For example, a rotating electric machine according to an embodiment may be a three-phase motor. That is, in a rotating electric machine according to an embodiment, the number m of phases may be three.

In addition, in the above-described embodiments, the case where the rotating electric machine according to the embodiment is a motor has been described as an example, but the present invention is not limited thereto. A rotating electric machine according to an embodiment may be a generator that converts mechanical energy into electrical energy instead of a motor that converts electrical energy into mechanical energy.

The preferred embodiments of the present invention have been described above. However, the present invention is not limited to the above-described embodiments. That is, the present invention includes embodiments subjected to various modifications, substitutions, design changes, and the like based on the gist of the present invention, and does not exclude these embodiments.

What is claimed is:

1. A stator comprising:
a stator core in which a plurality of slots is formed; and
a coil being open winding, in which one pole of one phase includes n (n: even number) slots, a number of phases is m (m: 2 or 3), an end portion of a winding start is electrically joined to a wire inserted in an outermost diameter turn of a slot, an end portion of a winding end is electrically joined to a wire inserted in an outermost diameter turn of a slot, and a wire wound up to an end of an innermost diameter turn of a slot and a wire inserted in a slot shifted by (n−1)×m−1 slots in a winding direction or a direction opposite to the winding direction from the slot in which the wire is inserted in the innermost diameter turn of the slot are electrically joined.

2. A stator comprising:
a stator core in which a plurality of slots in each of which a wire is capable of being wound p (p: even number) turns is formed; and
a coil in which one pole of one phase includes n (n: even number) slots, an end portion of a winding start is electrically joined to a wire inserted in a first turn from an outer diameter side of a slot, an end portion of a winding end is electrically joined to a wire inserted in a second turn from an outer diameter side of a slot, and when the coil is wound from an outer diameter side of a slot to a p-th turn and then folded back to the outer diameter side of the slot, the coil is electrically joined to a wire inserted on an outer diameter side by one turn in a slot shifted by n×2+1 slots in a winding direction, is wound around the stator core once, and is electrically joined to a wire inserted on an outer diameter side by three turns in a slot shifted by n×2+2 slots in the winding direction.

3. The stator according to claim 2,
wherein a plurality of slots in each of which a wire is capable of being wound p (p: even number of six or more) turns is formed in the stator core, and
the coil is wound up to a second turn from an outer diameter side of the stator core by repeating further electrically joining the coil to a wire inserted on an outer diameter side by three turns in a slot shifted by n 2−2 slots in the winding direction, winding the coil around the stator core once, and electrically joining the coil to a wire inserted on an outer diameter side by three turns in a slot shifted by n×2+2 slots in the winding direction.

4. The stator according to claim 1,
wherein the coil is open winding, one pole of one phase includes n (n: even number) slots, the number of phases is m (m: 2 or 3), and m×u×2 terminals incorporated in a u-parallel circuit are arranged to be shifted from each other in a direction of a rotation axis of a rotor.

5. The stator according to claim 1,
wherein the coil includes a bus bar that electrically joins a terminal incorporated in a u-parallel circuit and the end portion of the winding start or the end portion of the winding end, and a part of the bus bar from a portion starting to overlap a back yoke of the stator core in a direction of a rotation axis of a rotor to the end portion of the winding start or the end portion of the winding end is laid in a region overlapping the back yoke in the direction of the rotation axis.

6. The stator according to claim 1,
wherein the coil is open winding, one pole of one phase includes n (n: an even number) slots, the number of phases is m (m: 2 or 3), and a slot in which an end portion of a winding start of a first phase is inserted and a slot in which an end portion of a winding start of a second phase different from the first phase is inserted are arranged apart from each other by n×2 slots or more.
